(19) United States
(12) Patent Application Publication
(10) Pub. No.: US 2016/0073029 A1
(43) Pub. Date: Mar. 10, 2016

(54) METHOD AND SYSTEM FOR CREATING A VIDEO

(71) Applicant: Guy MARKOVITZ, Tel Aviv (IL)

(72) Inventor: Guy MARKOVITZ, Tel Aviv (IL)

(21) Appl. No.: 14/479,329

(22) Filed: Sep. 7, 2014

(51) Int. Cl. H04N 5/232

(52) U.S. Cl. CPC H04N 5/23293; H04N 5/23216

(57) ABSTRACT

A system and method for creating a video, the system comprising at least one camera for video photographing and a processor configured to make changes in a video during the video photographing and to record the resulted video with the changes. The method comprises video photographing by a camera and making changes in the video by a processor during the video photographing and recording the resulted video with the changes by the processor.

### BACKGROUND OF THE INVENTION

Some known methods may include displaying a lecture on a screen with a virtual background behind the lecturer. Some methods include controlling of the video and adding interactive media to the displayed video.

U.S. Patent Application Publication No. 2013/0314421 discloses Lecture method and device in a virtual lecture room, in which a presentation content of various inputs (cameras, notebook computer, motion pictures) is combined with a virtual lecture room using a Chromakey or TOF technique, so displaying a lecture and a presentation content on one screen with a beautiful background studio screen.

U.S. Patent Application Publication No. 2011/0242277 discloses systems and methods for embedding a forground video into a background feed based on a control input, wherein a color image and a depth image of a live video are received and processed to identify the foreground and the background of the live video. The background of the live video is removed in order to create a foreground video that comprises the foreground of the live video and the foreground video may be embedded into a second background from a background feed. The background feed may also comprise virtual objects such that the foreground video may interact with the virtual objects.

U.S. Pat. No. 8,508,614 discloses teleprompting system and method, including use of a touch-screen interface positioned intermediate to the user and a camera such that the camera captures the user's image through a transparency of the touch-screen interface. The touch screen interface is coupled to a computer and is operably connected so as to enable user control and manipulation of interactive media content generated by the computer. A video mixing component integrates images captured by the camera with interactive media content generated by the computer, as may be manipulated by the user via the touch-screen interface, to generate a coordinated presentation. The coordinated presentation can be received by one or more remote devices. The remote devices can further interact with at least the interactive media content.

### SUMMARY OF THE INVENTION

Embodiments of the present invention may provide a system and method for creating a video, wherein the system may include: at least one camera for video photographing; and a processor configured to make changes in a video during the video photographing, and to record the resulted video with the changes.

In some embodiments of the present invention, the system may further include a three-dimensional sensor configured to sense body gestures of a presenter photographed by the camera, wherein the processor is configured to translate the sensed body gestures to commands and to make changes in the video during the video photographing based on these commands.

In some embodiments of the present invention, the processor is configured to make changes in the video according to pre-loaded commands in pre-defined times.

In some embodiments of the present invention, the processor is configured to replace a background of the video behind a presenter photographed by the camera with a virtual background and to record the video with the replacement virtual background.

In some embodiments of the present invention, the replacement background includes a pre-loaded slide presentation, wherein the processor is configured to change the slides of the slide presentation in a predetermined pace or in specifically pre-indicated times.

In some embodiments of the present invention, the processor is configured to receive in advance commands and data that relate to a certain slide of a slide presentation displayed in the recorded video, wherein the data and commands are entered with relation to specified times during the video in which the data and commands apply.

In some embodiments of the present invention, the system may further include a display configured to display the resulted video and teleprompting text, wherein the teleprompting text is scrolled up automatically according to predetermined pace and/or timing and/or may be scrolled up manually during the video recording, i.e. by providing real-time commands to scroll the text. The teleprompting text may include commands for the processor, wherein the processor may be configured to perform the commands in timing corresponding to the location of the command in the teleprompting text.

In some embodiments of the present invention, the processor is configured to make during the video capturing at least one of the changes in a list comprising: a change in the zooming of the background, moving/sliding of the background, a change in the angle of view or zoom of the camera, of the kind of shot taken of the photographed person and insertion of an image or text into the video.

In some embodiments of the present invention, the processor is further configured to add objects to the video, for example according to pre-entered commands or according to commands provided by the presenter's body gestures.

In some embodiments of the present invention, the processor is configured to record actions performed in the video during the video capturing in an action log, wherein each action is recorded with relation to the location of the action on the screen and/or with relation to the time of action, and wherein a viewer of the resulted video can navigate through the video by selecting a certain action from the action log. In some embodiments, the action log may be an XML file or any other kind of database file, and/or the processor may be configured to insert an interactive object to the video during the video recording, and to synchronize the action log with the video to enable link to certain internet pages based on the interactive object.

In some embodiments of the present invention, the method may further include creating the resulted video in a transparent format for integration with web pages, wherein parameters of the resulted video may be changed after the video recording is finished by a dedicated application programming interface or managing interface.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for creating a video according to some embodiments of the present invention;

FIG. 2 is a schematic illustration of an exemplary screenshot of a dedicated software screen for recording a video according to some embodiments of the present invention;

FIG. 3 is a schematic illustration of an exemplary screenshot of a dedicated software screen for recording a video according to some embodiments of the present invention;

FIG. 4 is a schematic illustration of another exemplary screenshot of a dedicated software screen for recording a video according to some embodiments of the present invention;

FIGS. 5A and 5B are schematic illustrations of an exemplary real time command menu, according to some embodiments of the present invention; and

FIG. 6 is a schematic flowchart illustrating a method for creating a video according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the present invention may provide interactive video photography, for example, of presenters, instructors, teachers, lecturers, salespersons and or of any other suitable person, by using a three-dimensional sensor such as, for example, a depth sensor or camera. By utilizing three-dimensional sensing, embodiments of the present invention may provide manipulation of objects in the video according to three dimensional events sensed during the video photographing. In some embodiments of the present invention, a processor may receive pre-defined editing commands, which may be embedded in teleprompting text, thus allowing changes to be made in the video in appropriate times during the video recording. Some embodiments of the present invention may provide an action log that may enable navigation through the video according to the actions made in the recorded video. Additionally, some embodiments of the present invention may enable interactivity of the video with a viewer. These and other features provided by embodiments of the present invention are described in detail herein with reference to the drawings.

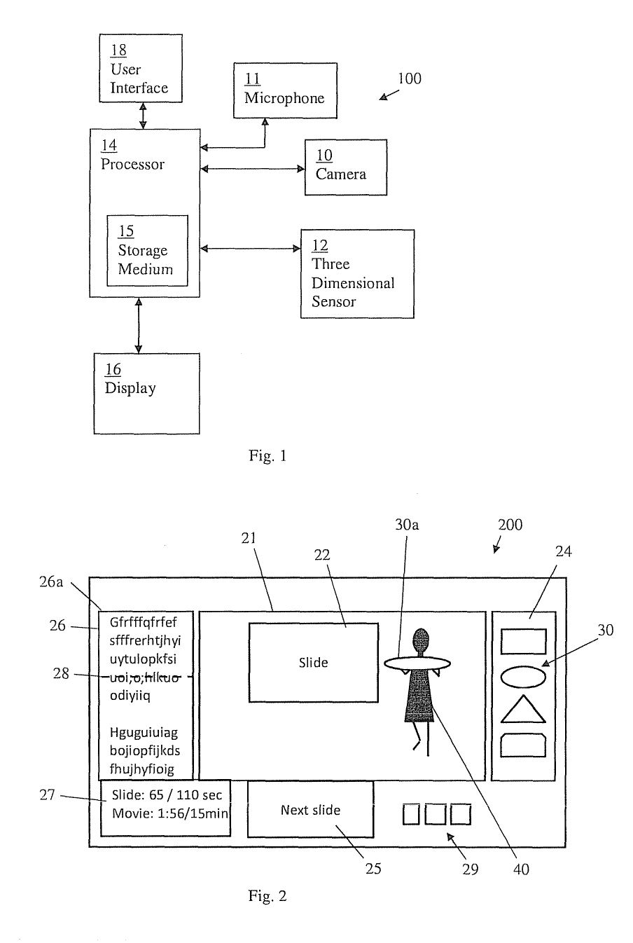

Reference is now made to FIG. 1, which is a schematic illustration of a system 100 for creating a video according to some embodiments of the present invention. System 100 may include at least one camera 10, a microphone (or any other voice input device) 11, a three-dimensional sensor/camera 12, a processor 14, a display 16 and user interface 18. Processor 14 may include or communicate with an article such as a computer or processor readable non-transitory storage medium 15, such as, for example a memory, a disk drive, or a USB flash memory encoding, including or storing instructions, e.g., computer-executable instructions, which when executed by processor 14, cause processor 14 to carry out the methods disclosed herein. Processor 14 may control and/or communicate with camera 10, three-dimensional sensor 12, display 16, user interface 18 and/or other units and modules of system 100, to perform the steps and/or functions described herein and/or to carry out methods disclosed herein.

System 100 may provide interactive video photography, for example, of presenters such as, for example, instructors, teachers, lecturers, salespersons and/or of any other suitable presenter person, by using three-dimensional sensor 12 such as, for example, a depth sensor or camera or any other suitable three-dimensional sensor. Camera 10 may video-photograph a person, for example in a speaking session. Processor 14 may insert changes to the video captured by camera 10, for example during the video capturing, and record the video with the changes. Processor 14 may insert the changes, for example, according to pre-loaded data, instructions and/or commands pre-entered by a user as described in detail herein. In order to perform some of the instructions, processor 14 may use depth-sensing abilities of three-dimensional sensor 12. Additionally, in some embodiments, processor 14 may perform actions according to commands received during the video capturing by camera 10 and/or during the display of the video.

It will be appreciated that in the present description, whenever video photographing, shooting, capturing and/or recording is mentioned, the act of video photographing, shooting, capturing and/or recording may include receiving voice input via microphone 11 and/or any other voice input device and/or recording the voice input, for example, the presenter's voice and/or any other voice input, synchronously with the video captured by camera 10.

Processor 14 may receive a replacement background, such as, for example, a slide presentation and/or a pre-designed background which may be prepared and/or pre-loaded by a user, for example via user interface 18. The background may include a static image and/or a video. A pre-designed background may be designed so that the pre-loaded slide presentation can be embedded, for example in a certain frame in the pre-designed background. In some embodiments of the present invention, a background and/or a scene behind the photographed person may be replaced with the replacement background by processor 14 during the photo-shooting by camera 10, without the need to place any special physical background behind the photographed person. For example, three-dimensional sensor 12 may recognize the background and/or the scene behind the photographed person. Based on the recognition by sensor 12, processor 14 may replace the background and/or a scene behind the photographed person with the replacement background. In some embodiments, processor 14 may replace the background and/or a scene behind the photographed person in a pre-defined moment, for example according to a pre-defined instruction entered by a user according to embodiments of the present invention, as described in detail herein.

It will be appreciated that in the present description, a slide presentation means an electronic slide presentation or slide show, for example, a series of slides in an electronic format, configured to be displayed one after the other, for example automatically in a certain predetermined pace or by setting in advance the timing of moving from one slide to the next one, or manually by determining in real time during the presentation when to move to the next slide. A slide of a presentation may contain text, images, graphs, tables, animation, graphical effects, embedded videos, links to other files and/or web addresses, and or any other suitable element that may be included in an electronic slide of a slide presentation/show.

Processor 14 may record the video photographed by camera 10, with the replacement background, which may be further changed by processor 14 during the video photography by camera 10. As mentioned, the replacement background may include a pre-loaded slide presentation. Therefore, the resulting recorded video may include a speaking person on the background including the pre-loaded slide presentation. The slides of the slide presentation may change, for example, by processor 14, in a predetermined pace or in specifically pre-indicated times. The background may be replaced by processor 14 according to predefined and/or real-time commands. For example, during or before displaying of a certain slide of the slide presentation during the video recording, processor 14 may activate background change according to a predefined and/or real-time command. For some slides, a command may be received and/or predefined to put no replacement background behind the presenter and/or to show in the recorded video the real photographed background behind the presenter and/or the real surroundings of the presenter.

In some embodiments of the present invention, a user may prepare in advance a lecture, lesson, presentation or any other suitable speaking session by entering in advance via user interface 18 data and/or commands that relate to a certain slide of the presentation. Processor 14 may receive and store the data and/or commands entered in advance. The entering of data and/or commands in advance may be performed, for example, for some of the slides or each slide of the slide presentation. The data and/or commands may be entered with relation to specified times during the video in which the commands and/or data apply and/or should be performed by processor 14. The data and/or commands may include, for example, text to be said and/or actions to be performed by processor 14 during the display time of a slide in the background of the photographed person during the video photography by camera 10 and/or in a pre-specified time during the video photography by camera 10. In some embodiments of the present invention, an action that may be entered in advance to be performed during a display of a slide in the background of the photographed person may include a change in the zooming of the background, moving/sliding of the background, a change in the angle of view of camera 10, of the kind of shot taken of the photographed person (such as long shot, medium shot, close-up) and/or of the zooming of the camera 10, and/or insertion of an image or text into the video shot taken by camera 10. Processor 14 may perform, during the video photography by camera 10, the actions according to the pre-entered data and/or commands, and record the video with the changes and/or actions performed during the video photography. The resulting video may be displayed on display 16.

Some of the actions that may be entered in advance to be performed during a display of a slide, according to embodiments of the present invention, may be performed by using three-dimensional sensor 12. Three-dimensional sensor 12 may recognize, for example, a photographed person, a background scene behind the person, the person's limbs and/or other body parts and/or their state, such as, for example, recognize whether a hand is open or close. For example, three-dimensional sensor 12 may recognize the photographed person's hands. In some embodiments of the present invention, an action that may be entered in advance to be performed by processor 10 during a display of a slide may include, for example, deleting and/or replacing of a background scene, placing of a picture and/or image, for example of an object, between the photographed person's hands, and/or any other suitable action that may be performed by using depth sensor 12.

Some embodiments of the present invention may provide dedicated software to facilitate execution of methods according to embodiments of the present invention. As mentioned above, such software may be stored in storage medium 15 and read by processor 14. When executed by processor 14, the software may cause processor 14 to carry out the methods disclosed herein.

Reference is now made to FIG. 2, which is a schematic illustration of an exemplary screenshot of a dedicated software screen 200 displayed, for example, on a display 16, for recording a video according to some embodiments of the present invention. Exemplary software screen 200 may include, for example, a video frame 21, a slide show/slide presentation frame 22, an object stock frame 24, and a teleprompter frame 26, and/or any other additional suitable elements, for example as described in detail herein.

Screen 200 may further include a timing window 27. In some embodiments of the present invention, for each slide of the presentation, the duration of displaying of that slide may be pre-estimated and/or predetermined, by processor 14 and/or by the user that may enter the duration to processor 14, for example based on a teleprompting text related to that slide. In some embodiments, the entire duration of the resulted video may be pre-estimated and/or predetermined, for example, based on a pre-entered teleprompting text and/or the duration of each slide. The time passed for a current slide and/or for the entire video out of the predetermined duration may be indicated in window 27. Screen 200 may further include a next slide window 25 previewing the next slide. Additionally, screen 200 may include any suitable control buttons 29.

According to some embodiments of the present invention. A user may upload and/or import a slide presentation to processor 14 or create a slide presentation on processor 14 by user interface 18, for example, a special software screen may be displayed to a user and/or enable a user to choose a slide presentation stored on processor 14 and/or upload and/or import a slide presentation to processor 14.

The resulted recorded video according to embodiments of the present invention may be displayed to the presenter/the user in screen 200, for example in video frame 21. In some embodiments of the present invention, the user may choose that the slide presentation will be inserted behind a presenter 40 in the resulted video according to embodiments of the present invention. As discussed in detail herein, in some other embodiments, the user may choose a background and/or scene from a plurality of pre-designed backgrounds and/or scenes to be inserted behind presenter 40 in the resulted video, for example backgrounds and/or scenes that simulate different appearances of studios, classrooms, halls, outside locations and/or any other suitable locations. Such backgrounds and/or scenes may include a presentation frame 22 where the slide presentation may be displayed.

For a certain slide, for example, for each slide, the user may enter teleprompting text to processor 14, to be said by a presenter in connection to the certain slide. The text may be displayed to the presenter, for example during the recording of the video by processor 14, for example on display 16. In some embodiments of the present invention, the text may be displayed in dedicated teleprompter frame 26, for example in dedicated software screen 200. The teleprompting text may be scrolled up automatically according to predetermined pace and/or timing and/or may be scrolled up manually, for example by providing real-time commands to scroll the text during the video recording. Additionally, a user may upload to processor 14 and/or choose from an inventory of objects stored in processor 14 images 30 to be used as illustration and/or demonstration objects, for example, for illustration and/or demonstration during the presentation. The images may be added to the video by processor 14, which may be displayed, for example, on display 16. In some embodiments of the present invention, the images may be displayed to the presenter in a dedicated virtual objects stock frame 24.

In some embodiments of the present invention, the various commands and/or instructions discussed herein for processor 14 that processor 14 may perform during the video photography by camera 10, may be entered to processor 14 within and/or in between the teleprompting text entered by the user. This way, processor 14 may perform the command exactly in the appropriate time during the speaking session. Additionally, this way the user and/or presenter may know what is about to happen in the recorded video concurrently with the presentation.

In some embodiments of the present invention, some of the actions processor 14 may perform and/or add to the recorded video, for example according to the commands entered by the user, may include a change of the kind of shot taken (such as long shot, medium shot, close-up), insertion of a virtual object, for example in and/or between the presenter's hands, insertion of text in the video frame(s) for the viewer of the video and/or for the presenter, for example a text label. In some embodiments, the commands may include a change of background in frame 21 and/or insertion of interactive objects such as, for example, a question that may be clicked and answered interactively by a viewer of the video during watching the presentation and/or a link in the video frame(s), on which the viewer can click during watching the video and get to a certain web page and/or to a certain time in the watched video.

In some embodiments of the present invention, as mentioned herein, an interactive object may include a question for a viewer that may be answered by a viewer interactively while the video is played. For example, in some embodiments, a multi-choice question with the optional answers may be presented upon the video, and the viewer may choose one of the possible answers. For example, the video may freeze during the presentation of the question until the viewer marks the chosen answer, and then the video may continue.

In teleprompting frame 26, the teleprompting text, commands and objects names may be presented in different colors, in order to distinguish between teleprompting text, commands and objects. For example, teleprompting text may be presented in a first color, commands may be presented in a second color, and objects may be presented in a third color. Additionally, different kinds of commands may be presented in corresponding different colors. During recording of the video by processor 14, the text in the teleprompting frame may roll up towards border 26a. An indicator 28 such as, for example, a broken line, an arrow and/or any other suitable indicator, may indicate to the user and/or presenter which portion of the text should be said in a certain time. When the indicator reaches a command entered in between the text, processor 14 may perform the action such as, for example, putting a selected virtual object 30a in the presenter's hands, as shown in the example of FIG. 2, or changing the kind of shot or making any other action and/or change mentioned herein by processor 14.

In some exemplary embodiments of the present invention, actions may be initiated by uttering of certain pre-defined key words by the presenter. The uttering of the specific words may be detected by microphone 11 or any other voice input device included, for example, in user interface 18 and/or in camera 10. The uttering of the specific words may be identified by processor 14, for example by speech recognition. Once identifying the uttering of one of the pre-defined key-words, processor 14 may translate the identified word into a pre-defined command related to the identified word. In some embodiments, the pre-definition of a key word may be performed by including the key word in the teleprompting text. The key-words may be marked by a specific color in which they may be presented. Once a presenter utters a key-word during the video recording, processor 14 may recognize the key-word marked in the teleprompting text and perform an action related to that key-word. For example, the word may be an object name. Once the presenter's utters the object's name during the video recording, processor 14 may recognize the object's name marked in the teleprompting text and perform an action related to that object's name such as, for example, putting an image of the object in the video, for example, making the object's image appear on screen, for example on and/or between the presenter's hand(s).

In some embodiments of the present invention, the timing in which the slides of the slide presentation in frame 22 change may be derived from the text and the actions, for example by determining that the duration of displaying of a certain slide depends on or equals, exactly or approximately, the length of the teleprompting text related to this slide divided by the speed of rolling of the text.

Processor 14 may record actions performed during and/or in the recorded video in an action log, for example in an XML file or any other suitable database file. For example, each action may be recorded with relation to the location of the action on the screen and/or with relation to the time of action. For example, when an interactive object is inserted by processor 14 during the video recording, for example according to a command in the teleprompting frame, the insertion of the object, the location of the object on the screen and/or the time of insertion of the object may be recorded in the XML file. In some embodiments, by synchronizing the XML file with the video, the clickable interactive objects may be added on the video frame and enable link to certain internet pages.

As mentioned herein, any action performed by processor 14 may be recorded in the action log. The action log record for a certain action may include the location of the action on the screen, the time of action and, in case the action involves, for example, a virtual and/or interactive object, the object parameters. For example, the object parameters of an interactive object may include a link address. Therefore, by synchronizing the action log with the recorded video, an internet wrapper may create links layer on top of the video, which may include clickable links corresponding to the objects included in the video.

Some of the actions, for example actions indicated within teleprompter frame 26, may be performed and/or triggered by a manual command by the presenter during the video recording, for example by using three-dimensional sensor 12. For example, insertion and/or removal of virtual objects and/or interactive objects may be performed by moving the presenter's hands, for example in the depth axis, or by any other suitable body gesture. Three-dimensional sensor 12 may sense the movement of hands. Upon the sensing by sensor 12, processor 14 may perform the required action.

For example, in some embodiments, a presenter may drag a virtual object by moving the presenter's hand(s), for example, in a certain minimal distance from the presenter's body in the depth axis, as described in detail herein. In order to stop the dragging, the presenter may leave the virtual object in a certain location on the screen, i.e. so that the virtual object may stop following the hands movement. For example, in order to leave the object, the presenter may further distance the presenter's hand(s) from the presenter's body, thus providing a command to processor 14 to leave the object at the current location.

In some embodiments of the present invention, the presenter may provide commands to pause and/or continue the photographing of the video, for example by performing certain pre-defined body gestures detected by three-dimensional sensor 12 and recognized by processor 14. Further, in some embodiments, the presenter may provide commands to play a segment of the recorded video, for example on display 16, for example the recent segment recorded and/or a segment related to a certain slide of the slide representation, and/or to re-shoot a video segment related to the certain slide, for example by certain pre-defined body gestures detected by three-dimensional sensor 12 and recognized by processor 14.

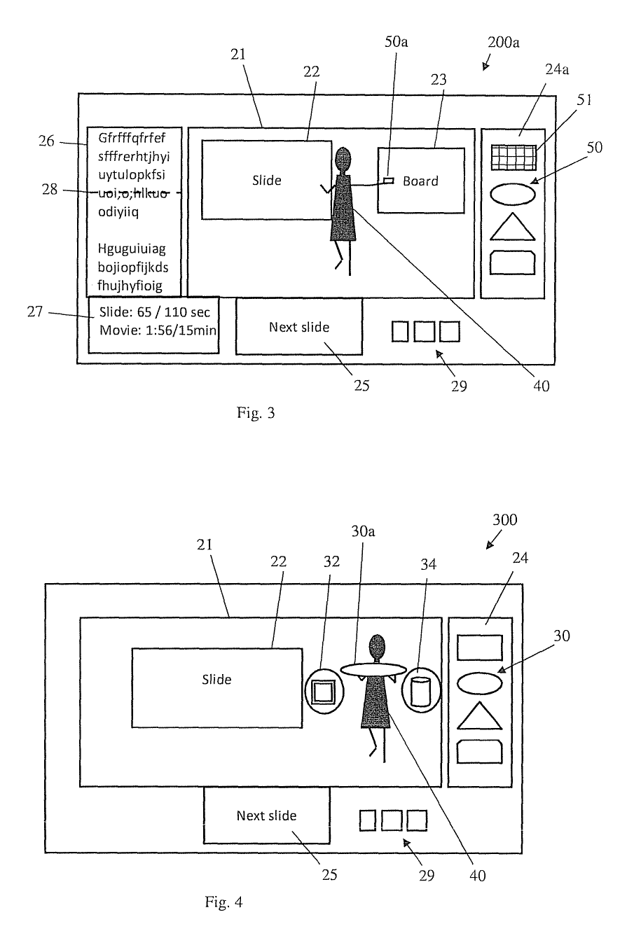

Reference is now made to FIG. 3, which is a schematic illustration of an exemplary screenshot of a dedicated software screen 200a displayed, for example, on a display 16, for recording a video according to some embodiments of the present invention. In some embodiments of the present invention, three-dimensional sensor 12 may sense and/or identify body gestures of the presenter such as, for example, location and/or movement of the presenter's limbs, hands, head and/or any other suitable body part during the video recording. Processor 14 may translate the identified gestures to commands that should be carried out during the video recording and/or added to the recorded video, synchronously with the corresponding identified body gestures. The presenter may look at display 16 during the presentation, for example looking at the video being recorded with the added background, teleprompter, and other frames and/or objects added to the recorded video by processor 14, and perform actions by certain, for example, predetermined, body gestures, for example in correspondence to certain objects and/or locations in the recorded video. Such body gestures may be translated by processor 14 to commands, instructing processor 14 to perform corresponding actions in the recorded video. For example, the presenter may draw on a virtual board 23, for example included in the background added by processor 14, by moving a hand in a corresponding manner over the board's virtual location, displayed, for example, in display 16. For example, screen 200a may include a color and/or drawing tool menu frame 24a, which may include, for example, a color plate 51 and/or tools menu 50, from which the presenter may select color and/or drawing tool such as, for example, tool 50a, by moving a hand over a corresponding location in the menu. For example, three-dimensional sensor 12 may identify when the hand of the presenter is closed, and as long as the hand is closed, processor 14 may draw on the board correspondingly to the hand movement. When the hand is identified as open, the drawing may stop.

Reference is now made to FIG. 4, which is a schematic illustration of another exemplary screenshot of a dedicated software screen 300 displayed, for example, on a display 16, for recording a video according to some embodiments of the present invention. As described herein, at least some of the commands for the formation of the recorded video by processor 14 may be provided in real time by presenter 40 during the video photographing and, for example, not by pre-entering the timed commands to processor 14. The commands may be provided by body gestures of presenter 40, as described in detail herein. In some embodiments of the present invention, the presenter does not have to follow a teleprompter's pace. In such embodiments, the presenter may perform actions freely according to the presenter's decisions during the video photographing, for example without pre-editing. For example, in order to insert a demonstration object 30a, the presenter may move or put the presenter's hand over the virtual location of object 30a on screen 300 and, for example, close the presenter's hand, and/or perform any other suitable body gesture. Once the gesture, for example, the hand closing over the virtual location of object 30a, is performed, the location of object 30a on screen 300 may become attached to the hand location on screen 300, i.e. the object will move on screen 300 together with the presenter's hand.

By moving the presenter's hand in the depth axis, for example forward or backwards, presenter 40 may open additional menus such as, for example, a command menu for actions to perform with object 30a. For example, by moving the presenter's hand in the depth axis, a menu may open which may enable the presenter to discard the object, for example to completely remove the object from frame 21, or, for example, to lock object 30a to a certain virtual location on screen 300 and/or stop the attachment of object 30a to the presenter's hand(s). For example, in order to discard or lock object 30a, the presenter may bring the hand(s) to which the object is attached forward. When the hand passes a certain threshold in the depth axis, for example if the hand passed a certain distance in the depth axis such as, for example, 0.4 meter, from the presenters shoulder, several icons may appear on screen 300, for example lock icon 32 and discard icon 34. By moving the presenter's hand over one of the icons 32 and 34, the corresponding command will be performed by processor 14.

Every action performed in the recorded video by processor 14, such as, for example, when an object 30 is taken from menu 24, i.e., selected from menu 24 by a corresponding body gesture as described herein, or when a virtual and/or interactive object is placed on the screen as described in detail herein, the action time in the video and the action details, such as, for example, the identity of the taken object, may be recorded in a file such as, for example, an action log as described in detail above. A viewer of the resulted video may navigate through the video by selecting a certain action from the action log, thus, for example, going straight to the time in the video the selection action is taking place.

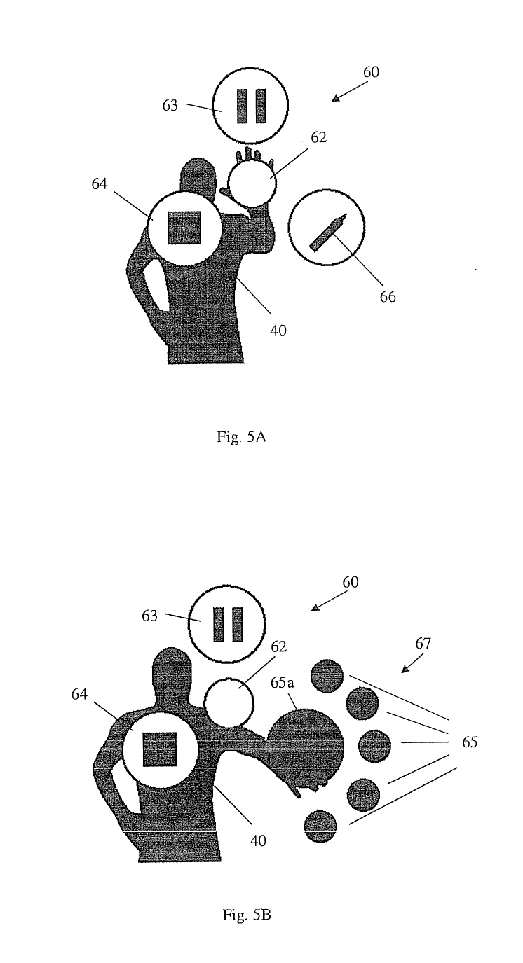

Reference is now made to FIGS. 5A and 5B, which are schematic illustrations of an exemplary real time command menu 60, according to some embodiments of the present invention. In some embodiments of the present invention, when the presenter's hand palm passes a certain distance in the depth axis as described herein, menu 60 may be opened, and show several action icons 63, 64 and 66, for example around a main menu button 62, for example in order to control events in the video. Presenter 40 may browse the menu by moving the presenter's hand from main menu button 62 to a selected action icon, for example while keeping the required distance of the hand palm, for example, from the presenter's shoulder. In order to select the action to be performed, the presenter should hold the presenter's hand over the selected icon for a while, for example for a predetermined short period of time, for example a second or less from a second or a few seconds. For example, icon 63 may be a pause icon. In order to have a pause in the video recording, presenter 40 may move the presenter's hand palm from main menu button 62 to pause icon 63 and/or hold the presenter's hand over the selected icon 63 for the required while. For example, icon 64 may be a stop icon. In order to stop the video recording, presenter 40 may move the presenter's hand palm from main menu button 62 to stop icon 64 and/or hold the presenter's hand over the selected icon 64 for the required while. Icon 66 may be, for example, a color selection menu icon, for example to draw on a virtual board as discussed above. In order to select a drawing color, presenter 40 may move the presenter's hand palm from main menu button 62 to color selection menu icon 66 and/or hold the presenter's hand over the selected icon 66 for the required while. Once the hand palm of presenter 40 is held over color selection menu icon 66 for the required while, color menu 67 may be opened. Color menu 67 may include several color icons 65 of various colors, and a selected color icon 65a. In order to select a color, presenter 40 may move the presenter's hand to a selected color icon 65, for example while keeping the required distance of the hand palm, for example, from the presenter's shoulder. In order to select the color to be used, the presenter should hold the presenter's hand over the selected color icon for a required while, for example for a predetermined short period of time, for example a second or less from a second or a few seconds. Once a color is selected, an image of a drawing tool (not shown) may appear on the presenter's hand palm in the recorded video, and/or the presenter may use the selected color for drawing, for example, on a virtual board as discussed in detail above.

In some embodiments of the present invention, a presenter/user may choose that the recorded video will show the actions mentioned and described in detail above with reference to FIGS. 1-4, 5A and 5B, performed by processor 14 and/or by the presenter's body gestures, without showing the presenter herself or himself in the video.

The resulted video, according to some of the various embodiments of the present invention, may be in a standard video format or, for example, in some embodiments, a special format with a transparent background, for example for use in web sites/pages. A transparent background may enable a viewer to see the website behind the played video. In some embodiments of the present invention some of the resulted video parameters may be determined and/or changed by a user in the resulted video, for example after the video recording is finished, according to the user's needs and/or preferences. For example, some of the parameters may be changed in order to adapt the resulted video to a specific web site/page, in which, for example, the video may be embedded. Some of the changeable parameters may include, for example, the video activation manner, the frame color/texture, addition, removal and/or change of control buttons such as, for example, stop, play and/or sound buttons and/or any other suitable parameters and/or buttons. After creation of the video according to the various embodiments of the present invention as described herein, the video may be embedded in a web site/page while controlling the mentioned parameters and/or other suitable parameters, for example, by a provided application programming interface (API). By such API, a user may determine, for example, that the video will be activated automatically upon entrance to the web site/page, or only after a play button is pushed/clicked, and/or determine/change any other suitable parameter. A user may control the parameters by embedding API code fragment in the website's HTML tags and/or scripts. Additionally or alternatively, some embodiments of the present invention may provide a built-in managing interface that, for example, may enable users to embed elements and control the mentioned parameters without writing code and/or making changes in the code level by themselves.

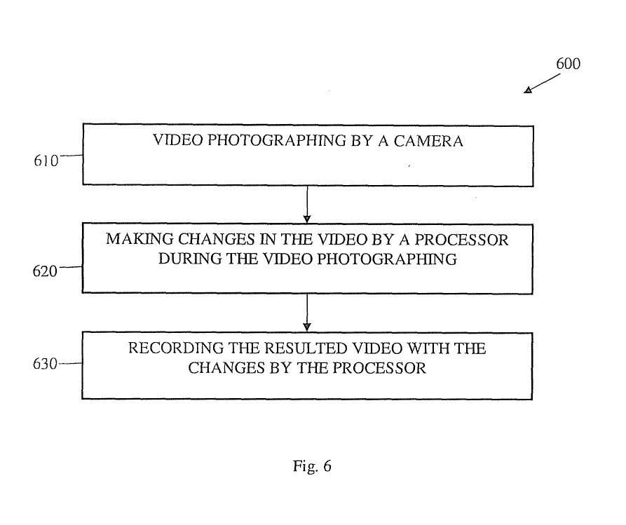

Reference is now made to FIG. 6, which is a schematic flowchart illustrating a method 600 for creating a video according to some embodiments of the present invention. As indicated in block 610, the method may include video photographing by a camera, for example as described in detail herein. As indicated in block 620, the method may include making changes in the video by a processor during the video photographing, for example as described in detail herein. As indicated in block 630, the method may include recording the resulted video with the changes by the processor, for example as described in detail herein.

In some embodiments, the method may further include sensing, by a three-dimensional sensor, body gestures of a presenter photographed by the camera, translating by the processor the sensed body gestures to commands and making changes in the video during the video photographing based on these commands, for example as described in detail herein with reference to FIGS. 1-4, 5A and 5B.

In some embodiments, the method may further include making changes in the video during the video recording according to pre-loaded commands in pre-defined times, for example as described in detail herein with reference to FIGS. 1-4.

In some embodiments, the method may further include replacing a background of the video behind a presenter photographed by the camera with a virtual background and recording the video with the replacement virtual background, for example as described in detail herein with reference to FIGS. 1-4, 5A and 5B. The replacement background may include a pre-loaded slide presentation, wherein the method may further include changing the slides of the slide presentation in a predetermined pace or in specifically pre-indicated times, for example as described in detail herein with reference to FIGS. 1-4.

In some embodiments, the method may further include receiving in advance commands and data that relate to a certain slide of a slide presentation displayed in the recorded video, wherein the data and commands are entered with relation to specified times during the video in which the data and commands apply, for example as described in detail herein with reference to FIGS. 1-4, 5A and 5B.

In some embodiments, the method may further include displaying the resulted video and teleprompting text, wherein the teleprompting text is scrolled up automatically according to predetermined pace and/or timing and/or may be scrolled up manually during the video recording. In some embodiments, the teleprompting text may include commands for the processor, wherein the method comprises performing the commands in timing corresponding to the location of the command in the teleprompting text, for example as described in detail herein with reference to FIGS. 1-3.

In some embodiments of the present invention, the changes made by the processor during the video capturing may include at least one of the changes in a list comprising: a change in the zooming of the background, moving/sliding of the background, a change in the angle of view or zoom of the camera, of the kind of shot taken of the photographed person and insertion of an image or text into the video, for example as described in detail herein with reference to FIGS. 1-4, 5A and 5B.

In some embodiments, the method may further include adding objects to the video, for example according to pre-entered commands or according to commands provided by the presenter's body gestures, for example as described in detail herein with reference to FIGS. 1-4, 5A and 5B.

In some embodiments, the method may further include recording actions performed in the video during the video capturing in an action log, wherein each action is recorded with relation to the location of the action on the screen and/or with relation to the time of action, and wherein a viewer of the resulted video can navigate through the video by selecting a certain action from the action log, for example as described in detail herein.

In some embodiments, the method may further include inserting an interactive object to the video during the video recording, and synchronizing the action log with the video to enable link to certain internet pages based on the interactive object, for example as described in detail herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for creating a video, the system comprising:
at least one camera for video photographing; and
a processor configured to make changes in a video during the video photographing, and to record the resulted video with the changes.

2. The system according to claim 1, further comprising a three-dimensional sensor configured to sense body gestures of a presenter photographed by the camera, wherein the processor is configured to translate the sensed body gestures to commands and to make changes in the video during the video photographing based on these commands.

3. The system according to claim 1, wherein the processor is configured to make changes in the video according to pre-loaded commands in pre-defined times.

4. The system according to claim 1, wherein the processor is configured to replace a background of the video behind a presenter photographed by the camera with a virtual background and to record the video with the replacement virtual background.

5. The system according to claim 4, wherein the replacement background includes a pre-loaded slide presentation, wherein the processor is configured to change the slides of the slide presentation in a predetermined pace or in specifically pre-indicated times.

6. The system according to claim 1, wherein the processor is configured to receive in advance commands and data that relate to a certain slide of a slide presentation displayed in the recorded video, wherein the data and commands are entered with relation to specified times during the video in which the data and commands apply.

7. The system according to claim 1, further comprising a display configured to display the resulted video and teleprompting text, wherein the teleprompting text is scrolled down automatically according to predetermined pace and/or timing and/or may be scrolled down manually during the video recording.

8. The system according to claim 7, wherein the teleprompting text includes commands for the processor, wherein the processor is configured to perform the commands in timing corresponding to the location of the command in the teleprompting text.

9. The system according to claim 1, wherein the processor is configured to make during the video capturing at least one of the changes in a list comprising: a change in the zooming of the background, moving/sliding of the background, a change in the angle of view or zoom of the camera, of the kind of shot taken of the photographed person and insertion of an image or text into the video.

10. The system according to claim 1, wherein said processor is further configured to add objects to the video, for example according to pre-entered commands or according to commands provided by the presenter's body gestures.

11. The system according to claim 1, wherein the processor is configured to record actions performed in the video during the video capturing in an action log, wherein each action is recorded with relation to the location of the action on the screen and/or with relation to the time of action, and wherein a viewer of the resulted video can navigate through the video by selecting a certain action from the action log.

12. The system according to claim 11, wherein the processor is configured to insert an interactive object to the video during the video recording, and to synchronize the action log with the video to enable link to certain internet pages based on the interactive object.

13. A method for creating a video, the method comprising:
video photographing by a camera; and
making changes in the video by a processor during the video photographing; and
recording the resulted video with the changes by the processor.

14. The method according to claim 13, further comprising sensing, by a three-dimensional sensor, body gestures of a presenter photographed by the camera, translating by the processor the sensed body gestures to commands and making changes in the video during the video photographing based on these commands.

15. The method according to claim 13, comprising making changes in the video during the video recording according to pre-loaded commands in pre-defined times.

16. The method according to claim 13, comprising replacing a background of the video behind a presenter photographed by the camera with a virtual background and recording the video with the replacement virtual background.

17. The method according to claim 16, wherein the replacement background includes a pre-loaded slide presentation, wherein the method further comprises changing the slides of the slide presentation in a predetermined pace or in specifically pre-indicated times.

18. The method according to claim 13, further comprising receiving in advance commands and data that relate to a certain slide of a slide presentation displayed in the recorded video, wherein the data and commands are entered with relation to specified times during the video in which the data and commands apply.

19. The method according to claim 13, further comprising displaying the resulted video and teleprompting text, wherein the teleprompting text is scrolled up automatically according to predetermined pace and/or timing and/or may be scrolled up manually during the video recording.

20. The method according to claim 19, wherein the teleprompting text includes commands for the processor, wherein the method comprises performing the commands in timing corresponding to the location of the command in the teleprompting text.

21. The method according to claim 13, wherein the changes made by the processor during the video capturing include at least one of the changes in a list comprising: a change in the zooming of the background, moving/sliding of the background, a change in the angle of view or zoom of the camera, of the kind of shot taken of the photographed person and insertion of an image or text into the video.

22. The method according to claim 13, further comprising adding objects to the video, for example according to pre-entered commands or according to commands provided by the presenter's body gestures.

23. The method according to claim 13, further comprising recording actions performed in the video during the video capturing in an action log, wherein each action is recorded with relation to the location of the action on the screen and/or with relation to the time of action, and wherein a viewer of the resulted video can navigate through the video by selecting a certain action from the action log.

24. The method according to claim 23, further comprising inserting an interactive object to the video during the video recording, and synchronizing the action log with the video to enable link to certain internet pages based on the interactive object.

25. The method according to claim 13, further comprising creating the resulted video in a transparent format for integration with web pages, wherein parameters of the resulted video may be changed after the video recording is finished by a dedicated application programming interface or managing interface.
